(19) United States
(12) Patent Application Publication
(10) Pub. No.: US 2011/0069051 A1
(43) Pub. Date: Mar. 24, 2011

(54) DISPLAY

(75) Inventors: Kazuo Nakamura, Kanagawa (JP); Katsuhide Uchino, Kanagawa (JP); Hiroshi Hasegawa, Kanagawa (JP); Munenori Ono, Kanagawa (JP)

(73) Assignee: SONY CORPORATION, Tokyo (JP)

(21) Appl. No.: 12/879,563

(22) Filed: Sep. 10, 2010

(30) Foreign Application Priority Data
Sep. 18, 2009 (JP) 2009-217182

(51) Int. Cl. G09G 5/10

(52) U.S. Cl. 345/207

(57) ABSTRACT

A display unit including a display region including a plurality of luminescence elements, a non-display region including a plurality of luminescence elements and a photoreception element, a drive unit connected to each of the luminescence elements in the display region, a photoreception drive circuit connected to the plurality of luminescence elements in the non-display region, and a photoreception processing unit which receives a signal output from each of the plurality of luminescence elements in the non-display region and outputs a degradation signal to the drive unit, the drive unit providing a signal to the plurality of luminescence elements in the display region based on the degradation signal.

### CROSS-REFERENCE TO RELATED APPLICATIONS

The present application claims priority to Japanese Priority Patent Application JP 2009-217182 filed in the Japan Patent Office on Sep. 18, 2009, the entire content of which is hereby incorporated by reference.

### BACKGROUND OF THE INVENTION

The present invention relates to a display including a light-emitting element in a display panel.

### Background of the Invention

In recent years, in the field of displays displaying an image, displays using current drive type optical elements of which light emission luminance changes depending on the value of a current flowing therethrough, for example, organic EL (Electro Luminescence) elements as light-emitting elements of pixels have been developed for commercialization. Unlike liquid crystal elements or the like, the organic EL elements are self-luminous elements. Therefore, in a display (an organic EL display) using the organic EL elements, a light source (a backlight) is not necessary, so compared to a liquid crystal display needing a light source, a reduction in the profile of the display and an increase in the luminance of the display are allowed. In particular, in the case where the display uses an active matrix system as a drive system, each pixel continuously emits light, resulting a reduction in power consumption. Therefore, the organic EL display is expected to become a mainstream of next-generation flat panel display.

An issues exists when using current EL Elements in that the luminance if reduces due to a degradation in the elements according to the value of a current passing therethrough. Therefore, in the case where the organic EL elements are used as pixels of a display, the pixels may have different degradation states. For example, in the case where information such as time or a display channel is displayed in a fixed area of a display with high luminance for a long time, degradation in pixels located in the area accelerates. As a result, in the case where a picture with high luminance is displayed in an area including prematurely degraded pixels of the display, a phenomenon called burn-in in which the picture is displayed dark in the area including the prematurely degraded pixels only occurs. Burn-in is irreversible, so once burn-in occurs, the burn-in is permanent.

A large number of techniques of preventing burn-in have been proposed. For example, as described in Japanese Unexamined Patent Application Publication No. 2002-351403, there is disclosed a method of estimating a degree of degradation in a dummy pixel which is arranged outside a display region by detecting a terminal voltage when the dummy pixel emits light and then correcting a picture signal with use of the estimated degree of degradation. Moreover, for example, as described in Japanese Unexamined Patent Application Publication No. 2008-58446 and International Publication WO2006/046196, there are disclosed methods of arranging a photosensor in each display pixel and correcting a picture signal with use of a photoreception signal outputted from the photosensor.

### SUMMARY OF THE INVENTION

However, in the technique in Japanese Unexamined Patent Application Publication No. 2002-351403, the degree of degradation in a pixel in a display region is not estimated based on light emission information of the pixel in the display region, so a picture signal is not accurately corrected. Therefore, it is difficult to prevent burn-in. Moreover, in the techniques in Japanese Unexamined Patent Application Publication No. 2008-58446 and International Publication WO2006/046196, photoelectric conversion efficiency varies among photosensors in pixels. Therefore, for example, the magnitudes of photoreception signals from two pixels displaying with the same luminance may be different from each other. As a result, it is difficult to accurately prevent burn-in.

In accordance with principles of the invention, a display which allows accurate burn in prevention is provided.

According to one embodiment consistent with the present invention, there is provided a display including a display region including a plurality of luminescence elements, a non-display region including a plurality of luminescence elements and a photoreception element, a drive unit connected to each of the luminescence elements in the display region by a display region signal line, a photoreception drive circuit connected to the plurality of luminescence elements in the non-display region by a non-display signal line, and a photoreception processing unit which receives a signal output from each of the plurality of luminescence elements in the non-display region and outputs a degradation signal to the drive unit. Where the drive unit provides a signal to the plurality of luminescence elements in the display region based on the degradation signal.

In another embodiment consistent with the present invention, the drive unit adjusts the signal to the plurality of the luminescence elements in the display region based on the degradation signal.

In yet another embodiment consistent with the present invention, the photoreception unit determines the degradation signal based on the following equation:

Dᵢ=D^{n(Yi, Ys)}
where Dᵢ is the degradation rate of one of the plurality of luminescence elements in the non-display region, Dₛ is the degradation rate of a reference luminescence elements, and n(Yi,Ys) is an exponentiation factor of luminance of one of the plurality of luminescence elements in the non-display region with respect to a reference luminescence element selected by the photoreception processing unit.

In another embodiment consistent with the present invention, the photoreception unit determines the exponentiation factor based on the following equation

$$n ( {Y}_{i} , {Y}_{s} ) = \frac{Log ( {Y}_{i} ( {T}_{k} ) ) Log ( {Y}_{i} ( {T}_{k} - 1 ) )}{Log ( {Y}_{s} ( {T}_{k} ) ) Log ( {Y}_{s} ( {T}_{k} - 1 ) )}$$

where Ys(Tk) is a signal output from the reference luminescence element at a time Tk, Ys(Tk−1) is a signal output from the reference luminescence element at a time Tk−1, Yi(Tk) is a signal output from one of the plurality of luminescence elements in the non-display region at the time Tk, and Yi(Tk−1) is a signal output from one of the plurality of luminescence elements in the non-display region at the time Tk−1.

In another embodiment consistent with the present invention, the display unit includes a memory unit connected between the photoreception processing unit and the drive unit which stores the degradation signal before forwarding the signal to the drive unit.

In another embodiment consistent with the present invention, the photoreception drive circuit provides a constant signal to the plurality of luminescence elements in the non-display area.

In another embodiment consistent with the present invention, the reference luminescence element is one of the plurality of pixels in the non-display region.

In another embodiment consistent with the present invention, a constant sampling time period separates the time Tk from the time Tk−1 as defined by the following equation

Tₖ=Tₖ₋₁+ΔT

where ΔT is a constant time span.

In another embodiment consistent with the present invention, the time span ΔT is a variable time span.

Another embodiment consistent with the present invention provides method of adjusting the luminance of a display device which includes a display region having a plurality of luminescence elements and a non-display region having a plurality of luminescence elements with a photoreception element, the method comprising the steps of providing a control signal from a photoreception drive circuit to the plurality of luminescence elements in the non display region, receiving a signal output from each of the plurality of luminescence elements in the non-display region by a photoreception processing unit and determining a degradation rate of the luminescence elements in the non display region, outputting the degradation signal to the drive unit, and adjusting the signal sent from the drive unit to the luminescence elements in the display region by the degradation signal.

In another embodiment consistent with the present invention, the method includes the step of determining a degradation rate by the photoreception unit based on the following equation

Dᵢ=Dₛ^{n(Yi, Ys)}

where Dᵢ is the degradation rate of one of the plurality of luminescence elements in the non-display region, Dₛ is the degradation rate of a reference luminescence elements, and n(Yi,Ys) is an exponentiation factor of luminance of one of the plurality of luminescence elements in the non-display region with respect to a reference luminescence element selected by the photoreception processing unit.

In another embodiment consistent with the present invention, the exponentiation factor is determined by the photoreception unit based on the following equation

$$n ( {Y}_{i} , {Y}_{s} ) = \frac{Log ( {Y}_{i} ( {T}_{k} ) ) Log ( {Y}_{i} ( {T}_{k} - 1 ) )}{Log ( {Y}_{s} ( {T}_{k} ) ) Log ( {Y}_{s} ( {T}_{k} - 1 ) )}$$

where Ys(Tk) is a signal output from the reference luminescence element at a time Tk, Ys(Tk−1) is a signal output from the reference luminescence element at a time Tk−1, Yi(Tk) is a signal output from one of the plurality of luminescence elements in the non-display region at the time Tk, and Yi(Tk−1) is a signal output from one of the plurality of luminescence elements in the non-display region at the time Tk−1.

In another embodiment consistent with the present invention, the method includes the step of storing the degradation signal before forwarding the signal to the drive unit in a memory unit connected between the photoreception processing unit and the drive unit before the outputting step.

In another embodiment consistent with the present invention, the photoreception drive circuit provides a constant signal to the plurality of luminescence elements in the non-display area.

In another embodiment consistent with the present invention, the reference luminescence element is one of the plurality of pixels in the non-display region.

In another embodiment consistent with the present invention, a constant sampling time period separates the time Tk from the time Tk−1 as defined by the following equation

Tₖ=Tₖ₋₁+ΔT

where ΔT is a constant time span.

In another embodiment consistent with the present invention, the time span ΔT is a variable time span.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

FIG. 1 is a schematic view illustrating an example of a configuration of a display according to an embodiment of the invention.

FIG. 2 is a schematic view illustrating an example of a configuration of a pixel circuit.

FIG. 3 is a top view illustrating an example of a configuration of a display panel in FIG. 1.

FIG. 4 is a plot illustrating an example of a temporal change in luminance degradation rate of each initial luminance.

FIG. 5 is a plot illustrating an example of a relationship between a luminance degradation rate and a luminance degradation rate of a dummy pixel with initial luminance Y_{S}.

FIG. 6 is a plot illustrating an example of a relationship between an exponentiation factor n (Yᵢ, Yₛ) and an initial luminance ratio Yᵢ/Yₛ.

FIG. 7 is a plot illustrating an example of a relationship between an estimated value Y_{S2} of a luminance degradation rate at a time Tₖ and a measured value Y_{S1} of the luminance degradation rate at the time Tₖ.

FIG. 8 is a plot illustrating an example of a relationship between a luminance degradation function Fₛ(t) at a time Tₖ₋₁ and a luminance degradation function Fₛ(t) at the time Tₖ.

FIG. 9 is a conceptual diagram for describing an example of a method of calculating an exponentiation factor.

FIG. 10 is a plot illustrating an example of a relationship between an exponentiation factor n(Yᵢ, Yₛ) at the time Tₖ₋₁ and an exponentiation factor n(Yᵢ, Yₛ) at the time Tₖ.

FIG. 11 is a conceptual diagram for describing an example of a method of calculating a luminance degradation function Fᵢ(t).

FIG. 12 is a conceptual diagram for describing an example of a method of deriving an accumulated light emission time T_{xy} with reference luminance

FIG. 13 is a conceptual diagram for describing an example of a method of deriving a correction amount ΔS_{xy}.

FIG. 14 is a conceptual diagram for describing a correction method in related art.

FIG. 15 is a plot illustrating an example of a relationship between an acceleration factor α and a luminance degradation rate.

FIG. 16 is a plot illustrating another example of a relationship between an acceleration factor α and a luminance degradation rate.

FIG. 17 is an external perspective view of Application Example 1 of the display according to the above-described embodiment.

FIGS. 18A and 18B are an external perspective view from the front side of Application Example 2 and an external perspective view from the back side of Application Example 2, respectively.

FIG. 19 is an external perspective view of Application Example 3.

FIG. 20 is an external perspective view of Application Example 4.

FIGS. 21A to 21G illustrate Application Example 5, FIGS. 21A and 21B are a front view and a side view in a state in which Application Example 5 is opened, respectively, and FIGS. 21C, 21D, 21E, 21F and 21G are a front view, a left side view, a right side view, a top view and a bottom view in a state in which Application Example 5 is closed, respectively.

### DETAILED DESCRIPTION OF THE PREFERRED EMBODIMENTS

While various embodiments of the present invention have been described, it will be apparent to those of skill in the art that many more embodiments and implementations are possible that are within the scope of this invention. Accordingly, the present invention is not to be restricted except in light of the attached claims and their equivalents.

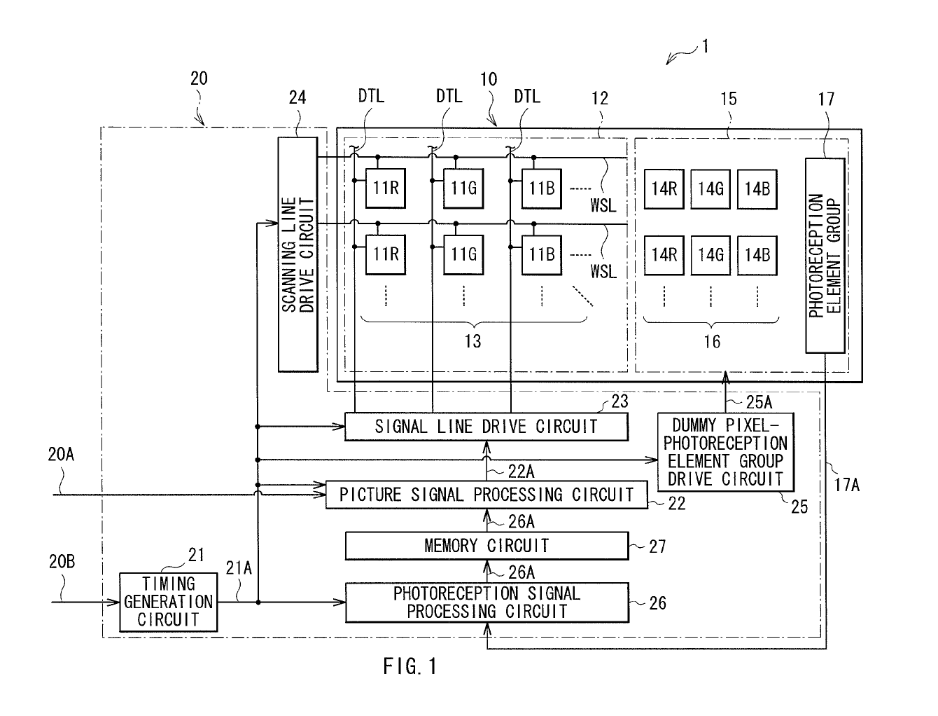

FIG. 1 illustrates a schematic configuration of a display 1 according to one embodiment consistent with the present invention. The display 1 includes a display panel 10 and a drive circuit 20 driving the display panel 10.

The display panel 10 includes a display region 12 in which a plurality of organic EL elements 11R, 11G and 11B are two-dimensionally arranged. In the embodiment, three adjacent organic EL elements 11R, 11G and 11B configures one pixel (one display pixel 13). In addition, the organic EL elements 11R, 11G and 11B are collectively called organic EL elements 11 as necessary. The display panel 10 also includes a non-display region 15 in which a plurality of organic EL elements 14R, 14G and 14B are two-dimensionally arranged. In this embodiment, three adjacent organic EL elements 14R, 14G and 14B configures one pixel (one dummy pixel 16). In addition, the organic EL elements 14R, 14G and 14B are collectively called organic EL elements 14 as necessary. In the non-display region 15, a photoreception element group 17 (a photoreception section) receives light emitted from the organic EL elements 14R, 14G and 14B. The photoreception element group 17 is configured of, for example, a plurality of photoreception elements (not illustrated). For example, the plurality of photoreception elements are two-dimensionally arranged so as to be paired with the organic EL elements 14, respectively, and each of the photoreception elements detects light (emission light) emitted from each dummy pixel 16 (each organic EL element 14) to output a photoreception signal 17A (luminance information) of each dummy pixel 16. Each photoreception element may include, but is not limited to, a photodiode or any other device capable of detecting light and outputting a photoreception signal.

The drive circuit 20 includes a timing generation circuit 21, a picture signal processing circuit 22, a signal line drive circuit 23, a scanning line drive circuit 24, a dummy pixel-photoreception element group drive circuit 25, a photoreception signal processing circuit 26 and a memory circuit 27.

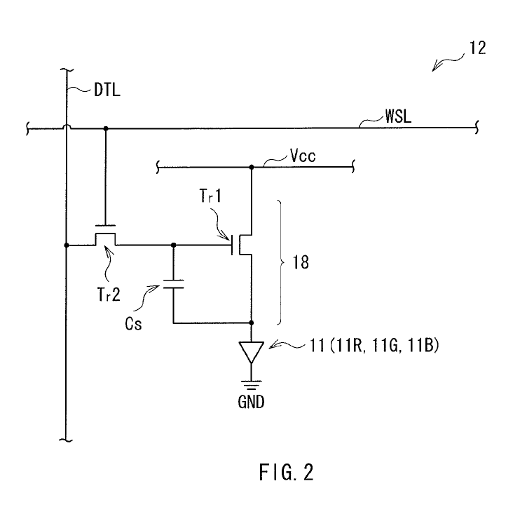

FIG. 2 illustrates one configuration of a circuit configuration in the display region 12. In the display region 12, a plurality of pixel circuits 18 are two-dimensionally arranged so as to be paired with the organic EL elements 11, respectively. Each of the pixel circuits 18 is configured of, for example, a drive transistor Tr₁, a writing transistor Tr₂ and a retention capacitor Cₛ, that is, each of the pixel circuits 18 has a 2Tr1C circuit configuration. The driving transistor Tr₁ and the writing transistor Tr₂ each are configured of, for example, an n-channel MOS type thin film transistor (TFT). The drive transistor Tr₁ or the writing transistor Tr₂ may be configured of, for example, a p-channel MOS type TFT.

In the display region 12, a plurality of signal lines DTL are arranged in a column direction, and a plurality of scanning lines WSL and a plurality of power supply lines Vcc are arranged in a row direction. One (one sub-pixel) of the organic EL elements 11R, 11G and 11B is arranged around each of intersections of the signal lines DTL and the scanning lines WSL. Each of the signal lines DTL is connected to an output end (not illustrated) of the signal line drive circuit 23 and a drain electrode of the writing transistor Tr₂. Each of the scanning lines WSL is connected to an output end (not illustrated) of the scanning line drive circuit 24 and a gate electrode of the writing transistor Tr₂. Each of the power supply lines Vcc is connected to an output end (not illustrated) of a power supply and a drain electrode of the drive transistor Tr₁. A source electrode of the writing transistor Tr₂ is connected to a gate electrode of the drive transistor Tr₁ and an end of the retention capacitor Cₛ. A source electrode of the drive transistor Tr₁ and the other end of retention capacitor Cₛ are connected to an anode electrode of the organic EL element 11. A cathode electrode of the organic EL element 11 is connected to, for example, a ground line GND.

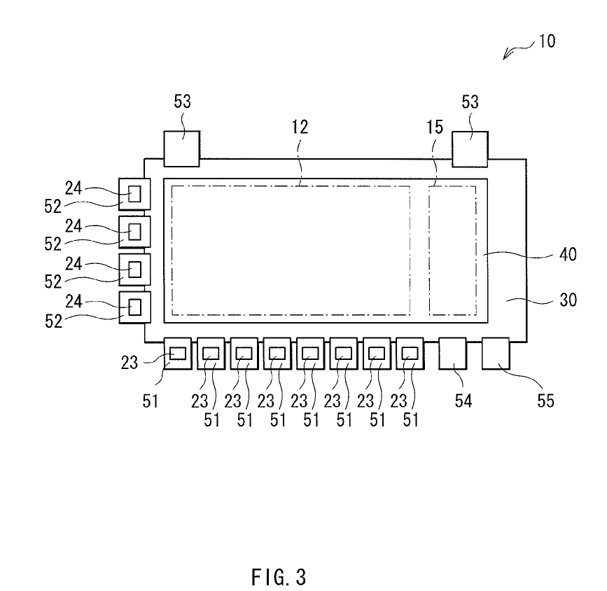

FIG. 3 illustrates one embodiment of a top configuration of the display panel 10 consistent with the present invention. The display panel 10 has, for example, a configuration in which a drive panel 30 and a sealing panel 40 are bonded together with a sealing layer (not illustrated) in between.

The drive panel 30 includes a plurality of organic EL elements 11 (not illustrated in FIG. 3) which are two-dimensionally arranged and a plurality of pixel circuits 18 (not illustrated in FIG. 3) which are arranged adjacent to the organic EL elements 11, respectively, in the display region 12. The drive panel 30 further includes a plurality of organic EL elements 14 (not illustrated in FIG. 3) which are two-dimensionally arranged and a plurality of photoreception elements (not illustrated in FIG. 3) which are arranged adjacent to the organic EL elements 14, respectively, in the non-display region 15.

As illustrated in FIG. 3, a plurality of picture signal supply TABs 51, a control signal supply TCP 54 and a photoreception signal output TCP55 are mounted on one side (a long side) of the drive panel 30. For example, scanning signal supply TABs 52 are mounted on another side (a short side) of the drive panel 30. Moreover, for example, a power supply TCP 53 is mounted on a side (a long side) different from the long side where the picture signal supply TABs 51 are mounted of the drive panel 30. The picture signal supply TABs 51 each are formed by interconnecting an integrated IC of the signal line drive circuit 23 to an opening of a film-shaped wiring board. The scanning signal supply TAB 52 is formed by interconnecting an integrated IC of the scanning line drive circuit 24 to an opening of a film-shaped wiring board. The power supply TCP 53 is formed by forming a plurality of wires which are electrically connected between an external power supply and the power supply lines Vcc on a film. The control signal supply TCP 54 is formed by forming a plurality of wires which are electrically connected between the external dummy pixel-photoreception element group drive circuit 25 and the dummy pixels 16 and between the dummy pixel-photoreception element group drive circuit 25 and the photoreception element group 17 on a film. The photoreception signal output TCP 55 is formed by forming a plurality of wires which are electrically connected between the external photoreception signal processing circuit 26 and the photoreception element group 17 on a film. In addition, the signal line drive circuit 23 and the scanning line drive circuit 24 are not necessarily formed with a TAB structure, and may be formed on, for example, the drive panel 30.

The sealing panel 40 includes, for example, a sealing substrate (not illustrated) sealing the organic EL elements 11 and 14 and a color filter (not illustrated). The color filter is provided in a region allowing light from the organic EL elements 11 to pass therethrough of a surface of the sealing substrate. The color filter includes, for example, a red filter, a green filter and a blue filter (all not illustrated) corresponding to the organic EL elements 11R, 11G and 11B, respectively. The sealing panel 40 further includes, for example, a light reflection section (not illustrated). The light reflection section reflects light emitted from the organic EL elements 14 so that the light enters into the photoreception element group 17, and the light reflection section is provided, for example, in a region allowing light from the organic EL elements 14 to pass therethrough of the surface of the sealing substrate.

Next, each circuit in the drive circuit 20 will be described below referring to FIG. 1. The timing generation circuit 21 controls the picture signal processing circuit 22, the signal line drive circuit 23, the scanning line drive circuit 24, the dummy pixel-photoreception element group drive circuit 25 and the photoreception signal processing circuit 26 to operate in synchronization with one another.

For example, the timing generation circuit 21 outputs a control signal 21A to each of the above-described circuits in response to (in synchronization with) a synchronization signal 20B inputted from outside. The timing generation circuit 21 is formed on a control circuit board (not illustrated) which is different from the display panel 10 together with the picture signal processing circuit 22, the dummy pixel-photoreception element group drive circuit 25, the photoreception signal processing circuit 26, the memory circuit 27 and the like.

As an illustrative example, the picture signal processing circuit 22 corrects a digital picture signal 20A inputted from outside in response to (in synchronization with) input of the control signal 21A, and converts the corrected picture signal 20A into an analog signal to output the analog signal to the signal line drive circuit 23. In the embodiment, the picture signal processing circuit 22 corrects the picture signal 20A with use of correction information 26A (which will be described later) read out from the memory circuit 27. The picture signal processing circuit 22 reads out, as the correction information 26A, a correction amount ΔS_{xy} (which will be described later) of each of display pixels 13 for one line from the memory circuit 27 in each horizontal period, and then corrects the picture signal 20A with use of the read correction amount ΔS_{xy} to output a picture signal 22A which is obtained by correction to the signal line drive circuit 23.

The signal line drive circuit 23 outputs the analog signal 22A inputted from the picture signal processing circuit 22 to each signal line DTL in response to (in synchronization with) input of the control signal 21A. For example, as illustrated in FIG. 3, the signal line drive circuit 23 is provided in each of the picture signal supply TABs 51 mounted on a side (a long side) of the drive panel 30. The scanning line drive circuit 24 sequentially selects one scanning line WSL from a plurality of scanning lines WSL in response to (in synchronization with) input of the control signal 21A. For example, as illustrated in FIG. 3, the scanning line drive circuit 24 is provided in each of the scanning signal supply TABs 52 mounted on another side (a short side) of the drive panel 30.

Referring again to FIG. 1, the photoreception signal processing circuit 26 derives the correction information 26A based on the photoreception signal 17A inputted from the photoreception element group 17, and then outputs the derived correction information 26A to the memory circuit 27 in response to (in synchronization with) input of the control signal 21A. In addition, a method of deriving the correction information 26A will be described later. The memory circuit 27 stores the correction information 26A inputted from the photoreception signal processing circuit 26. The memory circuit 27 is allowed to read out the stored correction information 26A by the picture signal processing circuit 22.

The dummy pixel-photoreception element group drive circuit 25 allows constant currents with different magnitudes to flow through the dummy pixels 16, respectively, so that the dummy pixels 16 emit light in response to (in synchronization with) input of the control signal 21A. In the case where the number of dummy pixels 16 is n, the dummy pixel-photoreception element group drive circuit 25 allows a constant current with a magnitude allowing a pixel to have initial luminance Y₁ to flow through a first dummy pixel 16, and allows a constant current with a magnitude allowing a pixel to have initial luminance Y₂(>Y₁) to flow through a second dummy pixel 16. Moreover, the dummy pixel-photoreception element group drive circuit 25 allows a constant current with a magnitude allowing a pixel to have initial luminance Yᵢ(>Yᵢ₋₁) to flow an ith dummy pixel 16, and allows a constant current with a magnitude allowing a pixel to have initial luminance Yₙ(>Yₙ₋₁) to flow through an nth dummy pixel 16. For example, the dummy pixel-photoreception element group drive circuit 25 measures a time when a current flows through each dummy pixel 16.

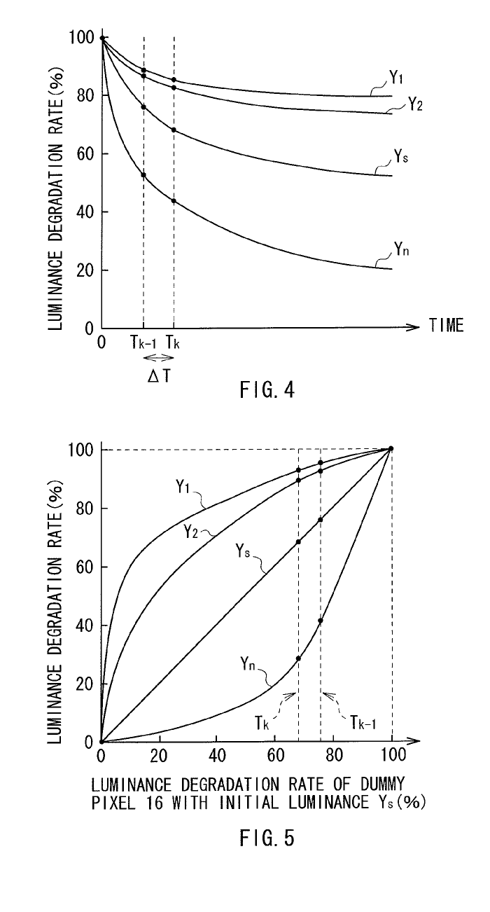

In addition, even if a constant current continuously flows through each dummy pixel 16, for example, as illustrated in FIG. 4, the luminance of each dummy pixel 16 is gradually reduced over time, because the organic EL element 14 included in each dummy pixel 16 degrades with an increase in a current-carrying time (an accumulated light emission time). As a result, the light emission luminance is reduced according to a progress degree of degradation in the organic EL element 14. In addition, Yₛ in FIG. 4 is initial luminance of a pixel selected as a reference pixel (which will be described later) from the dummy pixels 16.

Moreover, the transition of the luminance degradation rate of each dummy pixel 16 is not uniform. For example, as illustrated in FIG. 5, in the case where a horizontal axis in FIG. 5 indicates the luminance degradation rate of the pixel (the dummy pixel 16) set as the reference pixel, it is obvious that at first, the transition of the luminance degradation rate of a dummy pixel 16 with smaller initial luminance than the initial luminance Yₛ of the reference pixel is more moderate than the transition of luminance degradation in the reference pixel. On the other hand, it is obvious that at first, the transition of the luminance degradation rate of a dummy pixel 16 with larger initial luminance than the initial luminance Yₛ of the reference pixel is steeper than the transition of luminance degradation in the reference pixel. The transition of the luminance degradation rate of each dummy pixel 16 exemplified in FIG. 5 is represented by the following expression.

Dᵢ=Dₛ^{n(Yi, Ys)} Mathematical Expression 1

In Mathematical Expression 1, Dᵢ represents a luminance degradation rate of the ith dummy pixel 16. Dₛ represents a luminance degradation rate of the reference pixel. Moreover, n(Yᵢ, Yₛ) represents an exponentiation factor of luminance of the ith dummy pixel 16 with respect to luminance of the reference pixel. For example, as illustrated in the following expression, the exponentiation factor n(Yᵢ, Yₛ) is derived by dividing (Log(Yᵢ(Tₖ))−Log(Yᵢ(Tₖ₋₁))) by (Log(Yₛ(Tₖ)−Log(Yₛ(Tₖ₋₁))).

$$n ( {Y}_{i} , {Y}_{s} ) = \frac{Log ( {Y}_{i} ( {T}_{k} ) ) Log ( {Y}_{i} ( {T}_{k} - 1 ) )}{Log ( {Y}_{s} ( {T}_{k} ) ) Log ( {Y}_{s} ( {T}_{k} - 1 ) )} \qquad Mathematical Expression 2$$

In Mathematical Expression 2, Log(Yₛ(Tₖ)), Log(Yₛ(Tₖ₋₁)), Log(Yᵢ(Tₖ)) and Log(Yᵢ(Tₖ₋₁)) represent a logarithm of Yₛ(Tₖ), a logarithm of Yₛ(Tₖ₋₁), a logarithm of Yᵢ(Tₖ) and a logarithm of Yᵢ(Tₖ₋₁), respectively. In addition, the denominator (Log(Yₛ(Tₖ))−Log(Yₛ(Tₖ₋₁))) in the right-hand side of Mathematical Expression 2 corresponds to a specific example of “first luminance degradation information” in the invention. Moreover, the numerator (Log(Yᵢ(Tₖ))−Log(Yᵢ(Tₖ₋₁))) in the right-hand side of Mathematical Expression 2 corresponds to a specific example of “second luminance degradation information” in the invention.

Moreover, in Mathematical Expression 2, Yₛ(Tₖ) represents a photoreception signal 17A (luminance information) of the reference pixel at the time Tₖ, and corresponds to latest luminance information in luminance information of the reference pixel. Moreover, Yₛ(Tₖ₋₁) represents the photoreception signal 17A (luminance information) of the reference pixel at the time Tₖ₋₁(<time Tₖ), and corresponds to earlier luminance information in the luminance information of the reference pixel. Yᵢ(Tₖ) represents the photoreception signal 17A (luminance information) of the ith dummy pixel 16 at the time Tₖ, and corresponds to latest luminance information in luminance information of the ith dummy pixel 16 (a non-reference pixel). Yᵢ(Tₖ₋₁) represents the photoreception signal 17A (luminance information) of the ith dummy pixel 16 at the time Tₖ₋₁, and corresponds to earlier luminance information in the luminance information of the ith dummy pixel 16 (a non-reference pixel). A relationship between the time Tₖ₋₁ and the time Tₖ is represented by, for example, the following expression.

Tₖ=Tₖ₋₁+ΔT Mathematical Expression 3

In Mathematical Expression 3, ΔT represents a sampling period. In this case, the sampling period ΔT indicates, for example, a period in which the photoreception signal processing circuit 26 derives a value of the denominator and a value of the numerator in the right-hand side of Mathematical Expression 2. The photoreception signal processing circuit 26 consistently keeps the sampling period ΔT constant.

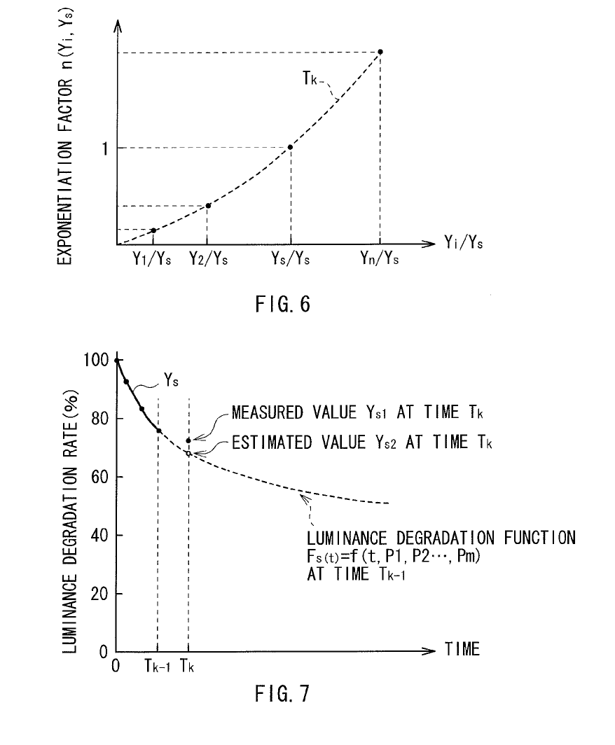

For example, as illustrated in FIG. 6, in the case where the horizontal axis in FIG. 6 indicates a ratio (Yᵢ/Yₛ) of the initial luminance Yᵢ of each dummy pixel 16 to the initial luminance Yₛ of the reference pixel, an upward-sloping curve indicating an increase in the exponentiation factor n(Yᵢ, Yₛ) at the time Tₖ derived in the above-described manner associated with an increase in the initial luminance Yᵢ is drawn. It is obvious from Mathematical Expression 2 that the exponentiation factor n(Yᵢ, Yₛ) is 1 in Yₛ/Yₛ.

Next, referring to FIGS. 7 to 13, a method of deriving correction information 26A used for correction of the picture signal 20A will be described below.

In one embodiment consistent with the present invention, the photoreception signal processing circuit 26 selects one pixel from a plurality of dummy pixels 16 as a reference pixel. In the embodiment, the selected dummy pixel 16 is consistently set as the reference pixel without changing the reference pixel to any other dummy pixel 16 (non-reference pixel).

Next, the photoreception signal processing circuit 26 obtains the photoreception signals 17A from the photoreception element group 17 at times T₁ and T₂. More specifically, at the times T₁ and T₂, the photoreception signal processing circuit 26 obtains the photoreception signals 17A (first luminance information) of the reference pixel which is one pixel selected from the plurality of dummy pixels 16. Moreover, at the times T₁ and T₂ the photoreception signal processing circuit 26 obtains the photoreception signals 17A (second luminance information) of a plurality of non-reference pixels which are all of the plurality of dummy pixels 16 except for the reference pixel from the photoreception element group 17. Then, the photoreception signal processing circuit 26 derives luminance degradation information (Log(Yₛ(T₂))−Log(Yₛ(T₁))) of the reference pixel from luminance information of the reference pixel, and derives luminance degradation information (Log(Yᵢ(T₂))−Log(Yᵢ(T₁))) of each non-reference pixel from luminance information of each non-reference pixel.

Next, the photoreception signal processing circuit 26 derives the exponentiation factor n(Yᵢ, Yₛ) of the luminance information of each non-reference pixel with respect to the luminance information of the reference pixel at the time T₂ from the luminance degradation information of the reference pixel and the luminance degradation information of each non-reference pixel. Then, the photoreception signal processing circuit 26 derives a luminance degradation function Fₛ(t) (a first luminance degradation function) at the time T₂ representing a temporal change in luminance of the reference pixel from the luminance information of the reference pixel. Moreover, the photoreception signal processing circuit 26 derives a luminance degradation function Fᵢ(t) (a second luminance degradation function) at the time T₂ representing a temporal change in luminance of each non-reference pixel from the luminance degradation function Fₛ(t) and the exponentiation factor n(Yᵢ, Yₛ). Thus, the photoreception signal processing circuit 26 derives the luminance degradation functions Fₛ(t) and Fᵢ(t) at the time T₂ with use of initial luminance information.

Next, updating of data will be described below. At the times Tₖ₋₁ and Tₖ, the photoreception signal processing circuit 26 obtains the photoreception signals 17A (the first luminance information) of the reference pixel and the photoreception signals 17A (the second luminance information) of a plurality of non-reference pixels from the photoreception element group 17. A value (a measured value) of the photoreception signal 17A of the reference pixel at this time is Yₛ₁ (refer to FIG. 7). Next, the photoreception signal processing circuit 26 estimates luminance information of the reference pixel at the time Tₖ from the luminance degradation function Fₛ(t) at the time Tₖ₋₁. The estimated value at this time is Yₛ₂ (refer to FIG. 7). Then, the photoreception signal processing circuit 26 compares the measured value Yₛ₁ to the estimated value Yₛ₂ to determine whether or not the measured value Yₛ₁ and the estimated value Yₛ₂ are equal to each other. As a result, for example, in the case where the measured value Yₛ₁ is equal to the estimated value Yₛ₂, the photoreception signal processing circuit 26 considers the luminance degradation function Fₛ(t) at the time Tₖ₋₁ as the luminance degradation function Fₛ(t) at the time Tₖ. On the other hand, in the case where the photoreception signal processing circuit 26 determines that, for example, the measured value Yₛ₁ is different from the estimated value Yₛ₂ by comparing the measured value Yₛ₁ to the estimated value Yₛ₂, the photoreception signal processing circuit 26 derives the luminance degradation function Fₛ(t) (the first luminance degradation function) at the time Tₖ from the luminance information of the reference pixel.

Next, the photoreception signal processing circuit 26 derives the luminance degradation information (Log(Yₛ(Tₖ))−Log(Yₛ(Tₖ₋₁))) of the reference pixel from the luminance information of the reference pixel. Moreover, the photoreception signal processing circuit 26 derives the luminance degradation information (Log(Yᵢ(Tₖ))−Log(Yᵢ(Tₖ₋₁))) of each non-reference pixel from the luminance information of a plurality of non-reference pixels. Then the photoreception signal processing circuit 26 derives the exponentiation factor (Yᵢ, Yₛ) at the time Tₖ from the luminance degradation information of the reference pixel and the luminance degradation information of each non-reference pixel.

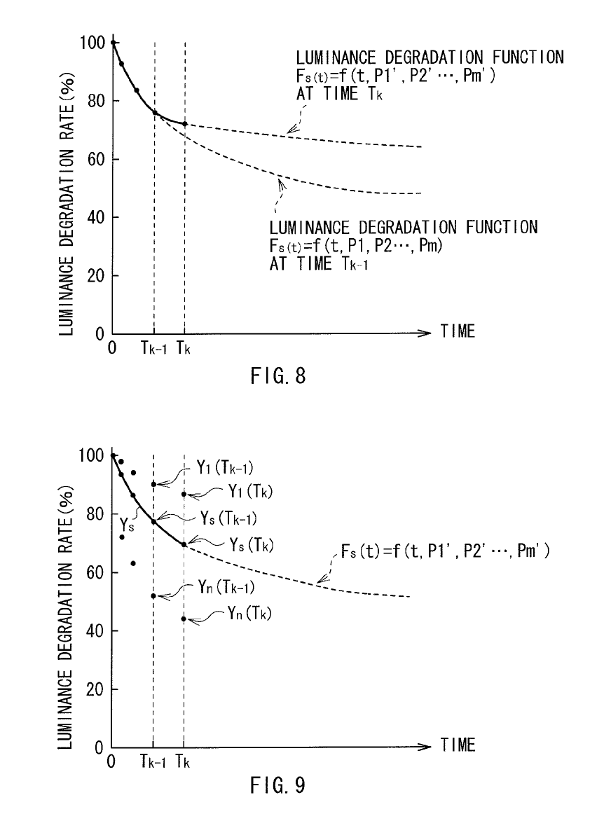

Next, the photoreception signal processing circuit 26 updates a parameter (for example, p1, p2, . . . , pm) of the luminance degradation function Fₛ(t) at the time Tₖ₋₁ to a parameter (for example, p1′, p2′, . . . , pm′) of the luminance degradation function Fₛ(t) at the time Tₖ (refer to FIG. 8). In other words, the photoreception signal processing circuit 26 updates the parameter of the luminance degradation function Fₛ(t) so as to correspond to the latest luminance information (Yₛ(Tₖ)) in the luminance information of the reference pixel and earlier luminance information (Ys(Tₖ₋₁)) in the luminance information of the reference pixel. The photoreception signal processing circuit 26 stores, for example, a newly determined parameter of the luminance degradation function Fₛ(t) in the memory circuit 27.

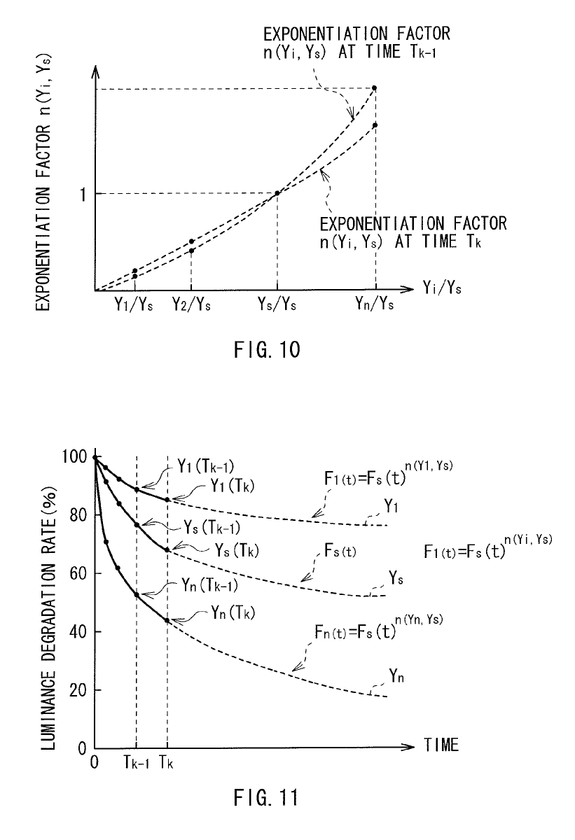

Next, the photoreception signal processing circuit 26 derives the luminance degradation function Fᵢ(t) (the second luminance degradation function) at the time Tₖ (refer to FIG. 11) from the luminance degradation function Fₛ(t) at the time Tₖ (refer to FIG. 9) and the exponentiation factor n(Yᵢ, Yₛ) (refer to FIG. 10). More specifically, the photoreception signal processing circuit 26 derives the luminance degradation function Fᵢ(t) at the time Tₖ by the following expression.

Fᵢ(t)=Fₛ(t)^{n(Yi, Ys)} Mathematical Expression 4

Then, the photoreception signal processing circuit 26 updates a parameter of the luminance degradation function Fᵢ(t) of each non-reference pixel at the time Tₖ₋₁ to a parameter of the luminance degradation function Fᵢ(t) of each non-reference pixel at the time Tₖ. The photoreception signal processing circuit 26 stores, for example, a newly determined parameter of the luminance degradation function Fᵢ(t) in the memory circuit 27.

Next, the photoreception signal processing circuit 26 estimates the luminance degradation rate of each display pixel 13 until the coming of the next sampling period. More specifically, the photoreception signal processing circuit 26 derives an accumulated light emission time T_{xy} on a reference luminance basis of each display pixel 13 from the luminance degradation function Fₛ(t), the luminance degradation function Fᵢ(t) and a history of the picture signal 20A of each display pixel 13. The photoreception signal processing circuit 26 determines the accumulated light emission time T_{xy} on the reference luminance basis of each display pixel 13 by, for example, the following method.

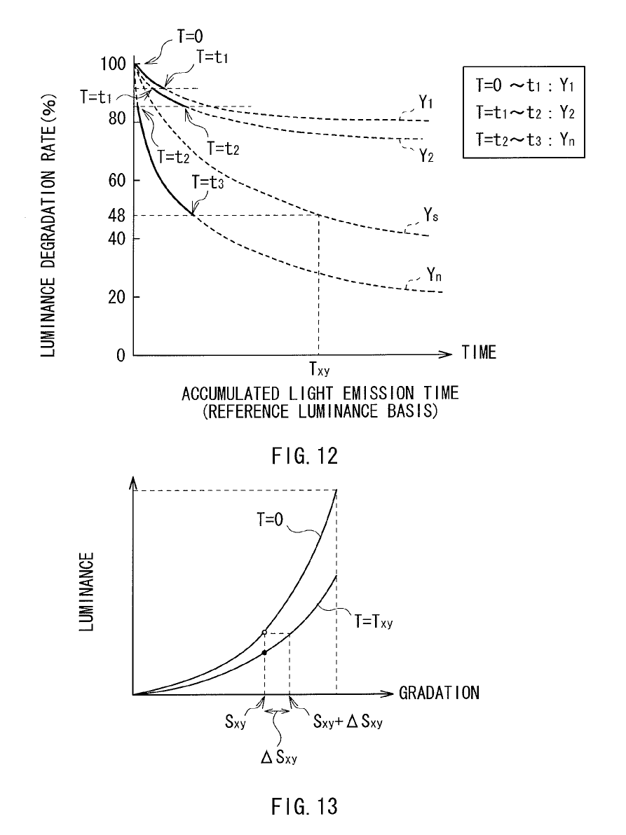

FIG. 12 schematically illustrates a process of deriving the accumulated light emission time T_{xy} on the reference luminance basis of each display pixel 13. For example, as illustrated in FIG. 12, a display pixel 13 emits light with initial luminance Y₁ during a time T=0 to t₁, and emits light with initial luminance Y₂ during a time T=t₁ to t₂, and emits light with initial luminance Yₙ during a time T=t₂ to t₃. Strictly speaking, at this time, the luminance of the display pixel 13 is degraded along a degradation curve of the initial luminance Y₁ during the time T=0 to t₁, and along a degradation curve of the initial luminance Y₂ during the time T=t₁ to t₂, and along a degradation curve of the initial luminance Yₙ during the time t₂ to t₃. As a result, the luminance of the display pixel 13 is degraded to, for example, 48% as illustrated in FIG. 12. Therefore, the accumulated light emission time T_{xy} on the reference luminance basis of the display pixel 13 is allowed to be determined by determining a time when a degradation rate reaches 48% in a luminance degradation curve (Fₛ(t)) of the reference pixel. Thus, the accumulated light emission time T_{xy} on the reference luminance basis of each display pixel 13 and a luminance degradation rate of each display pixel 13 are allowed to be determined by tracing a luminance degradation curve in each gradation level according to the magnitude (gradation) of an input signal.

Next, the photoreception signal processing circuit 26 derives a correction amount for a picture signal from the determined accumulated light emission time T_{xy} (or an estimated luminance degradation rate of each display pixel 13) and gamma characteristics of the display panel 10. The photoreception signal processing circuit 26 determines the correction amount for the picture signal by, for example, the following method.

FIG. 13 illustrates an example of a relationship between gradation (a value of the picture signal 20A) at T=0 and T_{xy} and luminance. Gradation-luminance characteristics at T=0 are so-called gamma characteristics. Gradation-luminance characteristics at T=T_{xy} are characteristics in which luminance in all gradation levels are attenuated to 48% with respect to the gamma characteristics. In this case, in the case where the value of the picture signal 20A in a certain display pixel 13 is S_{xy}, it is obvious that the luminance of the display pixel 13 has a value corresponding to a white dot in the drawing at an initial time. In other words, it is estimated that luminance of the display pixel 13 has a value attenuated from initial luminance to 48% after a lapse of the accumulated light emission time T_{xy} from the initial time.

Therefore, the photoreception signal processing circuit 26 derives a correction amount ΔS_{xy} which is added to the picture signal 20A (S_{xy}) so that luminance after a lapse of the accumulated light emission time T_{xy} from the initial time is equal to the initial luminance. Finally, the photoreception signal processing circuit 26 stores the correction amount ΔS_{xy} as correction information 26A in the memory circuit 27.

Next, an operation and effects of the display 1 according to one embodiment consistent with the present invention will be described below. The picture signal 20A and the synchronization signal 20B are inputted into the display 1. Thereby, each display pixel 13 is driven by the signal line drive circuit 23 and the scanning line drive circuit 24 so as to display a picture based on the picture signal 20A of each display pixel 13 on the display region 12. Moreover, each dummy pixel 16 is driven by the dummy pixel-photoreception element group drive circuit 25, and at the same time, the photoreception element group 17 is driven by the dummy pixel-photoreception element group drive circuit 25. Thereby, constant currents with different magnitudes flow through the dummy pixels 16, and each of the dummy pixels 16 emits light with luminance according to the magnitude of the constant current, and emission light from each of the dummy pixels 16 is detected by the photoreception element group 17. As a result, the photoreception signal 17A corresponding to emission light from each of the dummy pixels 16 is outputted. Next, the following process is performed by the photoreception signal processing circuit 26. That is, the exponentiation factor n(Yᵢ, Yₛ) of the photoreception signal 17A (luminance information) of a non-reference pixel with respect to the photoreception signal 17A (luminance information) of the reference pixel is derived from the photoreception signal 17A. Next, the luminance degradation function Fₛ(t) of the reference pixel is derived from the luminance information of the reference pixel, and the luminance degradation function Fᵢ(t) of the non-reference pixel is derived from the luminance degradation function Fₛ(t) and the exponentiation factor n(Yᵢ, Yₛ). Then, the accumulated light emission time T_{xy} on the reference luminance basis of each display pixel 13 and the luminance degradation rate of each display pixel 13 are estimated with use of the luminance degradation function Fₛ(t), the luminance degradation function Fᵢ(t) and the history of the picture signal 20A of each display pixel 13. Next, the correction amount ΔS_{xy} is added to the picture signal 20A (S_{xy}) of each display pixel 13 so that luminance after a lapse of the accumulated light emission time T_{xy} from the initial time is equal to the initial luminance. Thereby, the luminance of each display pixel 13 becomes initial luminance.

Thus, in the embodiment, the luminance degradation rate of each display pixel 13 is estimated with use of the luminance degradation function Fₛ(t), the luminance degradation function Fᵢ(t) obtained from the luminance degradation function Fₛ(t) and the exponentiation factor n(Yᵢ, Yₛ), and the history of the picture signal 20A of each display pixel 13. Thereby, luminance degradation in each display pixel 13 is allowed to be estimated at high accuracy, so an accurate correction amount ΔS_{xy} is allowed to be added to the picture signal 20A (S_{xy}) of each display pixel 13 so that the luminance of each display pixel 13 becomes the initial luminance. As a result, burn-in is accurately preventable.

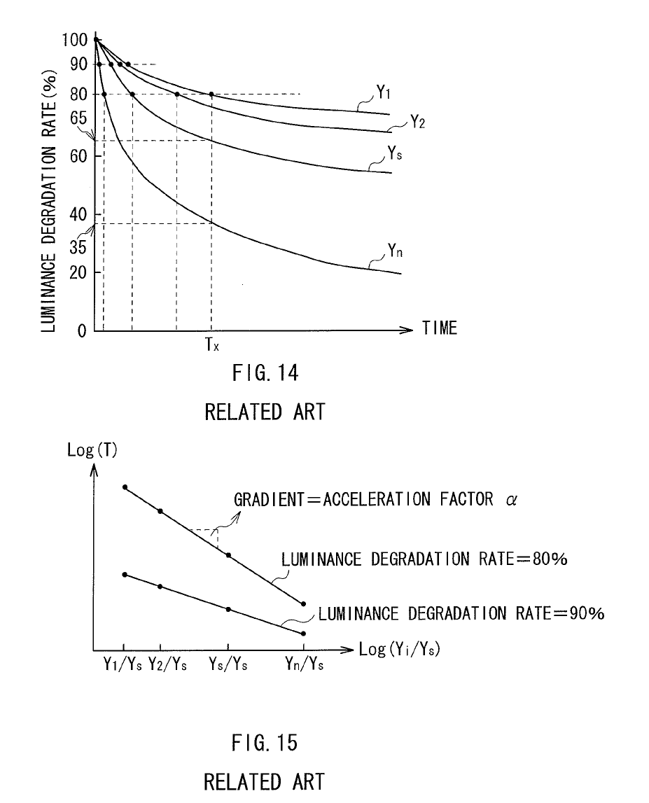

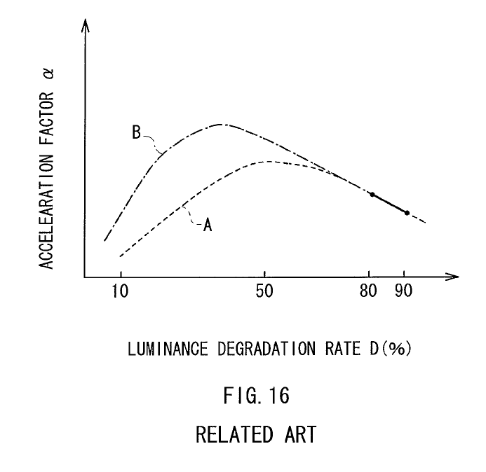

As one of techniques of estimating the luminance degradation rate of each display pixel 13, for example, a method using an acceleration factor α is used. In this method, first, for example, as illustrated by a broken line in FIG. 14, a time T when the luminance degradation rate of the dummy pixel 16 with initial luminance Yᵢ becomes equal to the luminance degradation rate of the dummy pixel 16 with initial luminance Yₛ is determined. Next, for example, as illustrated in FIG. 15, in the case where a horizontal axis indicates Log(Yᵢ/Yₛ) and a vertical axis indicates Log(T), the time T is plotted, and dots of each luminance degradation rate are connected with a straight line, and then a gradient of the straight line of each luminance degradation rate is determined. The gradient is the above-described acceleration factor α. Next, for example, as illustrated in FIG. 16, in the case where a horizontal axis indicates a luminance degradation rate D and a vertical axis indicates the acceleration factor α, the acceleration factor α is plotted. Then, in this technique, the luminance degradation rate of each display pixel 13 is estimated from black dots in FIG. 16 in which the accelerated factor α is plotted. More specifically, the luminance degradation rate of each display pixel 13 is estimated by the following expression.

$$T ( {D}_{x} , {Y}_{i} ) = T ( {D}_{x} , {Y}_{x} ) \times {( \frac{{Y}_{i}}{{Y}_{s}} )}^{α ( Dx )} \qquad Mathematical Expression 5$$

In Mathematical Expression 5, T(Dₓ, Yᵢ) represents a time (a reach time) until the dummy pixel 16 with the initial luminance Yᵢ reaches the luminance degradation rate Dₓ. T(Dₓ, Yᵢ) represents a time (a reach time) until the dummy pixel 16 with the initial luminance Yₛ reaches the luminance degradation rate Dₓ. Further, α(Dₓ) represents an acceleration factor α in the luminance degradation rate Dₓ.

However, in the above-described technique, the following issue arises. For example, as illustrated in FIG. 14, it is assumed that the luminance degradation rate of the dummy pixel 16 with the initial luminance Yᵢ is determined until a time Tₓ and at this time, the luminance degradation rate of the dummy pixel 16 with the initial luminance Y₁ is 80%. The luminance degradation rate of the dummy pixel 16 with initial luminance Yᵢ except for the initial luminance Y₁ is typically smaller than 80%. at the time Tₓ. For example, the luminance degradation rate of the dummy pixel 16 with initial luminance Yₛ is 65% at the time Tₓ, and the luminance degradation rate of the dummy pixel 16 with initial luminance Yₙ is 35% at the time Tₓ. The acceleration factor α is derived by determining a time necessary to reach a certain degradation rate in all dummy pixels 16 with the initial luminance Y₁ to Yₙ. Therefore, only an acceleration factor α when the luminance degradation rate is 100% to 85% is determined from data of the luminance degradation rate of each dummy pixel 16 obtained until the time Tₓ. As a result, the acceleration factor α when the luminance degradation rate is smaller than 85% is only estimated. Therefore, for example, as illustrated in FIG. 16, it may be uncertain that a relationship between the acceleration factor α and the luminance degradation rate establishes a curve A or a curve B. Therefore, in the method using the acceleration factor α, estimation accuracy of the luminance degradation rate of each display pixel 13 varies depending on a progress degree of luminance degradation in the dummy pixel 16 with the initial luminance Y₁. When luminance degradation in the dummy pixel 16 with the initial luminance Y₁ progresses, a relationship between the acceleration factor α and the luminance degradation rate is clear. However, the luminance degradation in the dummy pixel 16 with the initial luminance Y₁ is generally very moderate, so to obtain a necessary relationship between the acceleration factor α and the luminance degradation rate for estimation, observation for a very long period is necessary. Therefore, the method using the acceleration factor α is not realistic.

On the other hand, in the embodiment, the luminance degradation rate of each display pixel 13 is allowed to be estimated from data (Yₛ(Tₖ), Yₛ(Tₖ₋₁)) at the time of observation. Thereby, luminance degradation in each display pixel is allowed to be estimated at high accuracy without observation for a long time. Therefore, an estimating method in the embodiment is extremely realistic. Moreover, in the embodiment, the luminance degradation rate of each display pixel 13 is allowed to be estimated from data (Yₛ(Tₖ), Yₛ(Tₖ₋₁)) at the time of observation, so a memory amount and a calculation amount which are necessary for updating are allowed to be reduced.

In the above-described embodiment, each of the dummy pixels 16 with initial luminance Y₁ to Yₙ is configured of a single pixel including a combination of organic EL elements 14R, 14G and 14B, but each dummy pixel 16 (a low-luminance pixel) with low initial luminance Yᵢ may be configured of a plurality of dummy pixels (second dummy pixels) (not illustrated). In such a case, the photoreception signal processing circuit 26 is allowed to derive the denominator or the numerator in the right-hand side of Mathematical Expression 2 from an average value of luminance of the plurality of second dummy pixels. Thereby, a measurement error in the dummy pixel 16 with low luminance is allowed to be reduced, so luminance degradation in the display pixel 13 with low luminance is allowed to be estimated with high accuracy. As a result, burn-in is preventable more accurately.

Moreover, in the above-described embodiment, a specific dummy pixel 16 is consistently the reference pixel, but a dummy pixel 16 which has been a non-reference pixel may become the reference pixel. For example, when the photoreception signal processing circuit 26 detects that the luminance of the reference pixel reaches a predetermined value or less, the photoreception signal processing circuit 26 excludes the dummy pixel 16 which has been set as the reference pixel, and sets one pixel selected from a plurality of non-reference pixels as a new reference pixel. After that, the photoreception signal processing circuit 26 derives the denominator and the numerator in the right-hand side of Mathematical Expression 2 in the same manner. In such a case, even if a failure occurs in the reference pixel, luminance degradation is allowed to be estimated continuously. Thereby, reliability in estimation of luminance degradation is allowed to be improved.

Further, in the above-described embodiment, the sampling period ΔT is consistently constant, but the sampling period ΔT may be variable. For example, the photoreception signal processing circuit 26 may change the sampling period ΔT depending on an accumulated light emission time of the plurality of dummy pixels 16. In such a case, for example, when the accumulated light emission time T_{xy} reaches a long time, and luminance degradation hardly occurs, the sampling period ΔT is allowed to be extended. Thereby, a calculation amount necessary for updating is allowed to be reduced.

Moreover, in the above-described embodiment, the exponentiation factor n(Yᵢ, Yₛ) is derived with use of Mathematical Expression 2. However, for example, the exponentiation factor n(Yᵢ, Yₛ) may be derived with use of the following expressions.

$$\begin{matrix} n ( {Y}_{i} , {Y}_{s} ) = \frac{{Y}_{s} ( {T}_{k} )}{{Y}_{i} ( {T}_{k} )} \times \frac{\frac{d }{d t} ( {Y}_{i} ( {T}_{k} ) )}{\frac{d }{d t} ( {Y}_{s} ( {T}_{k} ) )} & Mathematical Expression 6 \\ n ( {Y}_{i} , {Y}_{s} ) = \frac{{Y}_{s} ( {T}_{k} )}{{Y}_{i} ( {T}_{k} )} \times \frac{{Y}_{i} ( {T}_{k} ) - {Y}_{i} ( {T}_{k - 1} )}{{Y}_{s} ( {T}_{k} ) - {Y}_{s} ( {T}_{k - 1} )} & Mathematical Expression 7\end{matrix}$$

In Mathematical Expression 6, the denominator of the second term in the right-hand side of Mathematical Expression 6 represents degradation speed of the reference pixel at the time Tk. The numerator of the second term in the right-hand side of Mathematical Expression 6 represents degradation speed of the non-reference pixel at the time Tk. The second term in the right-hand side of Mathematical Expression 7 is obtained by dividing the degradation speed of the reference pixel at the time Tk by the degradation speed of the non-reference pixel at the time Tk.

In the case where the exponentiation factor n(Yᵢ, Yₛ) is derived with use of Mathematical Expression 6 or 7, the exponentiation factor n(Yᵢ, Yₛ) is allowed to be derived only by four arithmetic operations, and logarithm calculation which is performed when Mathematical Expression 2 is used is not necessary. Therefore, in the modification, a calculation amount is allowed to be reduced to smaller than a calculation amount when the exponentiation factor n(Yᵢ, Yₛ) is derived with use of Mathematical Expression 2.

Next, application examples of the display 1 described in the above-described embodiment and the above-described modifications will be described below. The display 1 according to at least one embodiment consistent with the present invention are applicable to displays of electronic devices in any field which display a picture signal inputted from outside or a picture signal produced inside as an image or a picture, such as televisions, digital cameras, notebook personal computers, portable terminal devices such as cellular phones, and video cameras.

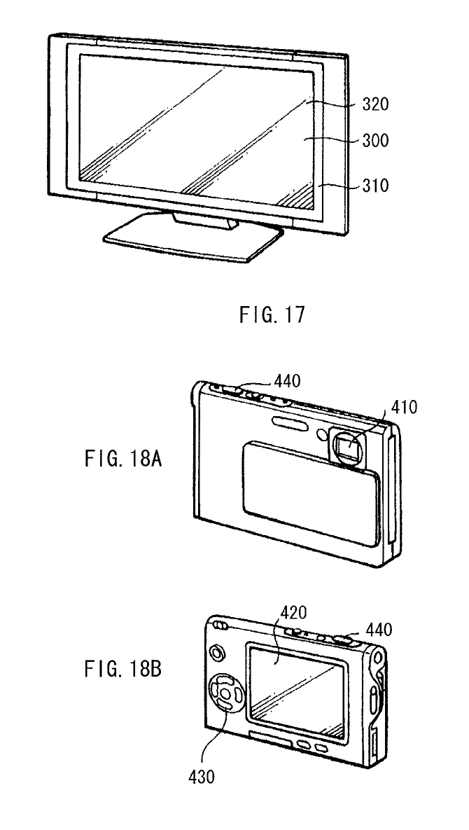

FIG. 17 illustrates a television to which a display unit consistent with the present invention is utilized. The television has, for example, a picture display screen section 300 including a front panel 310 and a filter glass 320. The picture display screen section 300 is configured of the display 1 according to the above-described embodiment or the like.

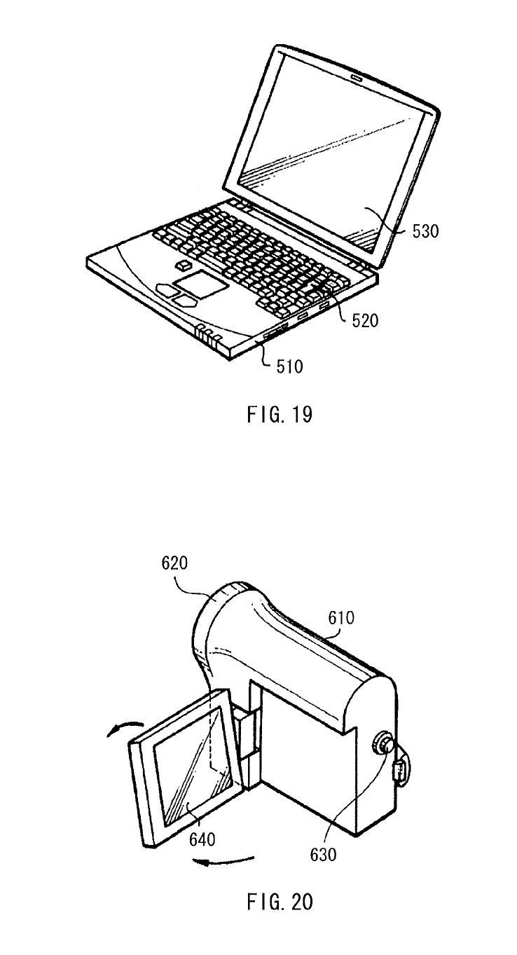

FIGS. 18A and 18B illustrate appearances of a digital camera to which a display 1 unit consistent with the present invention is utilized. The digital camera has, for example, a light-emitting section for a flash 410, a display section 420, a menu switch 430, and a shutter button 440. The display section 420 is configured of the display 1 according to the above-described embodiment or the like. FIG. 19 illustrates an appearance of a notebook personal computer to which a display 1 unit consistent with the present invention is utilized. The notebook personal computer has, for example, a main body 510, a keyboard 520 for operation of inputting characters and the like, and a display section 530 for displaying an image. The display section 530 is configured of the display 1 according to the above-described embodiment or the like.

FIG. 20 illustrates an appearance of a video camera to which the display 1 unit consistent with the present invention is utilized. The video camera has, for example, a main body 610, a lens for shooting an object 620 arranged on a front surface of the main body 610, a shooting start/stop switch 630, and a display section 640. The display section 640 is configured of the display 1 according to the above-described embodiment or the like.

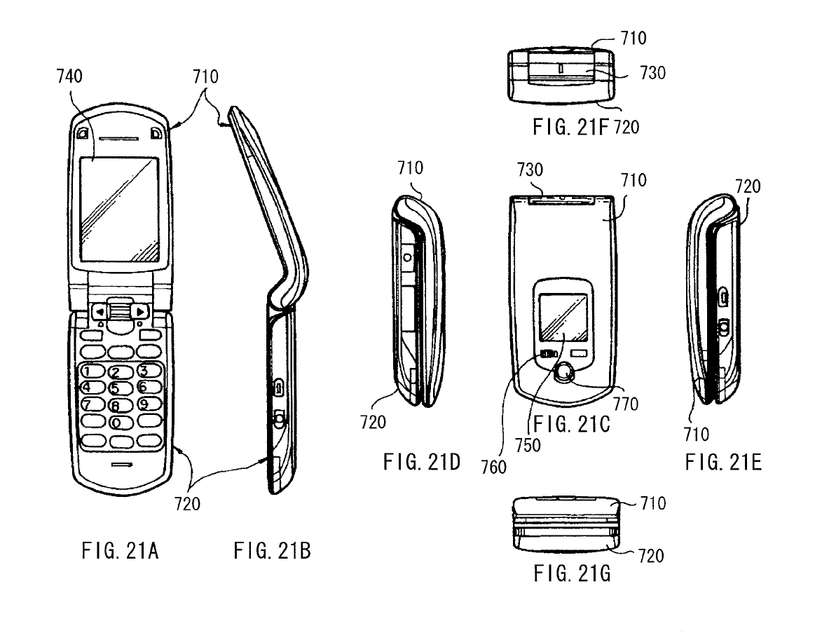

FIGS. 21A to 21G illustrate appearances of a cellular phone to which the display 1 unit consistent with the present invention is utilized. The cellular phone is formed by connecting, for example, a top-side enclosure 710 and a bottom-side enclosure 720 to each other by a connection section (hinge section) 730. The cellular phone has a display 740, a sub-display 750, a picture light 760, and a camera 770. The display 740 or the sub-display 750 is configured of the display 1 according to the above-described embodiment or the like.

It should be understood by those skilled in the art that various modifications, combinations, sub-combinations and alterations may occur depending on design requirements and other factors insofar as they are within the scope of the appended claims or the equivalents thereof.

What is claimed:

1. A display unit comprising:
a display region including a plurality of luminescence elements;
a non-display region including a plurality of luminescence elements, each with a corresponding photoreception element associated therewith;
a drive unit connected to each of the luminescence elements in the display region; and
a photoreception processing unit which receives a signal from each of photoreception elements and outputs a degradation signal to the drive unit based on the signals received,
wherein,
the drive unit provides a drive signal to the plurality of luminescence elements in the display region based on the degradation signal.

2. The display device of claim 1, wherein a photoreception drive unit provides a constant signal to each of the plurality of luminescence elements in the non-display area.

3. The display device of claim 1, wherein the drive unit provides at least two different constant signals to at least two of the plurality of luminescence elements in the non-display area.

4. The display device of claim 1, further comprising a memory unit connected between the photoreception processing unit and the drive unit and which stores the degradation signal before forwarding the degradation signal to the drive unit.

5. The display unit of claim 1, wherein
the photoreception processing unit determines the degradation signal based on the equation
Dᵢ=Dₛ^{n(Yi, Ys)},
where, Dᵢ is a degradation rate of one of the plurality of luminescence elements in the non-display region, Dₛ is a degradation rate of a reference luminescence elements, and n(Yi,Ys) is an exponentiation factor of luminance of one of the plurality of luminescence elements in the non-display region with respect to a reference luminescence element selected by the photoreception processing unit.

6. The display device of claim 5, wherein
the photoreception processing unit determines the exponentiation factor based on the equation
$$n ( {Y}_{i} , {Y}_{s} ) = \frac{Log ( {Y}_{i} ( {T}_{k} ) ) Log ( {Y}_{i} ( {T}_{k} - 1 ) )}{Log ( {Y}_{s} ( {T}_{k} ) ) Log ( {Y}_{s} ( {T}_{k} - 1 ) )} ,$$
where, Ys(Tk) is a signal output from the reference luminescence element at a time Tk, Ys(Tk−1) is a signal output from the reference luminescence element at a time Tk−1, Yi(Tk) is a signal output from one of the plurality of luminescence elements in the non-display region at the time Tk, and Yi(Tk−1) is a signal output from one of the plurality of luminescence elements in the non-display region at the time Tk−1.

7. The display device of claim 6, wherein the reference luminescence element is one of the plurality of pixels in the non-display region.

8. The display device of claim 6, wherein a constant sampling time period separates the time Tk from the time Tk−1 as defined by the equation
Tₖ=Tₖ₋₁+ΔT,
where, ΔT is a constant time span.

9. The display device of claim 8, wherein the time span ΔT is a variable time span.

10. A method of adjusting the luminance of a display device which includes (a) a display region having a plurality of luminescence elements and (b) a non-display region having a plurality of luminescence elements and a photoreception element, the method comprising the steps of:
providing a control signal from a photoreception drive circuit to the plurality of luminescence elements in the non display region;
receiving a signal output from each of the plurality of luminescence elements in the non-display region in a photoreception processing unit and determining a degradation signal for the luminescence elements in the non display region;
outputting the degradation signal to the drive unit; and
adjusting the signal sent from the drive unit to the luminescence elements in the display region by the degradation signal.

11. The method of claim 1, wherein a photoreception drive unit provides a constant signal to each of the plurality of luminescence elements in the non-display area.

12. The method of claim 11, wherein a photoreception drive unit provides at least two different signals to at least two of the plurality of luminescence elements in the non-display area.

13. The method of claim 10, further comprising a memory unit connected between the photoreception processing unit and the drive unit which stores the degradation signal before forwarding the signal to the drive unit.

14. The method of claim 10, wherein
the photoreception processing unit determines the degradation signal based on the following equation
D₁=Dₛ^{(Yi, Ys)},
where, Dᵢ is a degradation rate of one of the plurality of luminescence elements in the non-display region, Dₛ is a degradation rate of a reference luminescence elements, and n(Yi,Ys) is an exponentiation factor of luminance of one of the plurality of luminescence elements in the non-display region with respect to a reference luminescence element selected by the photoreception processing unit.

15. The method of claim 14, wherein
the photoreception processing unit determines the exponentiation factor based on the following equation
$$n ( {Y}_{i} , {Y}_{s} ) = \frac{Log ( {Y}_{i} ( {T}_{k} ) ) Log ( {Y}_{i} ( {T}_{k} - 1 ) )}{Log ( {Y}_{s} ( {T}_{k} ) ) Log ( {Y}_{s} ( {T}_{k} - 1 ) )} ,$$
where, Ys(Tk) is a signal output from the reference luminescence element at a time Tk, Ys(Tk−1) is a signal output from the reference luminescence element at a time Tk−1, Yi(Tk) is a signal output from one of the plurality of luminescence elements in the non-display region at the time Tk, and Yi(Tk−1) is a signal output from one of the plurality of luminescence elements in the non-display region at the time Tk−1.

16. The method of claim 15, wherein the reference luminescence element is one of the plurality of pixels in the non-display region.

17. The method of claim 15, wherein a constant sampling time period separates the time Tk from the time Tk−1 as defined by the following equation
Tₖ=Tₖ₋₁+ΔT,
where, ΔT is a constant time span.

18. The method of claim 17, wherein the time span ΔT is a variable time span.
